(19) United States
(12) Patent Application Publication
(10) Pub. No.: US 2025/0374068 A1
(43) Pub. Date: Dec. 4, 2025

(54) MEASURING AND MINIMIZING THE IMPACT OF CO-BAND MOBILITY ON TERRESTRIAL NETWORK PERFORMANCE DURING SATELLITE OVERPASS

(71) Applicants: AT&T Intellectual Property I, L.P., Atlanta, GA (US); AT&T Technical Services Company, Inc., Vienna, VA (US)

(72) Inventors: David Ross Beppler, Duluth, GA (US); Daniel Vivanco, Ashburn, VA (US)

(21) Appl. No.: 18/677,819

(22) Filed: May 29, 2024

(51) Int. Cl. H04W 16/14; H04W 24/08; H04W 84/06

(52) U.S. Cl. CPC H04W 16/14; H04W 24/08; H04W 84/06

(57) ABSTRACT

A method includes recording a first bitrate of a data transfer session between a user endpoint device and a network element of a terrestrial mobile network, wherein the user endpoint device is locked into a radio frequency band of the terrestrial mobile network, recording a second bitrate of the data transfer session, during a test interval in which a satellite of a non-terrestrial network that shares the radio frequency band with the terrestrial mobile network is executing a function that generates a data transmission to generate full-bandwidth noise signals, calculating a difference between the first bitrate that is recorded and the second bitrate that is recorded, and initiating, in response to the difference exceeding a threshold, an action to modify a parameter of at least one of the terrestrial mobile network or the non-terrestrial network to reduce an effect of channel interference resulting from the sharing of the radio frequency band.

The present disclosure relates generally to mobile networks and relates more particularly to devices, non-transitory computer-readable media, and methods for measuring and minimizing the impact of co-band mobility on terrestrial network performance during satellite overpass.

### BACKGROUND

In the field of mobile networking, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs.

### SUMMARY

In one example, the present disclosure describes a device, computer-readable medium, and method for measuring and minimizing the impact of co-band mobility on terrestrial network performance during satellite overpass. For instance, in one example, a method includes recording a first bitrate of a data transfer session between a user endpoint device and a network element of a terrestrial mobile network, wherein the user endpoint device is locked into a radio frequency band of the terrestrial mobile network, recording a second bitrate of the data transfer session, during a test interval in which a satellite of a non-terrestrial network that shares the radio frequency band with the terrestrial mobile network is executing a function that generates a data transmission to generate full-bandwidth noise signals, calculating a difference between the first bitrate that is recorded and the second bitrate that is recorded, and initiating, in response to the difference exceeding a threshold, an action to modify a parameter of at least one of the terrestrial mobile network or the non-terrestrial network to reduce an effect of channel interference resulting from the sharing.

In another example, a non-transitory computer-readable medium stores instructions which, when executed by a processor, cause the processor to perform operations. The operations include recording a first bitrate of a data transfer session between a user endpoint device and a network element of a terrestrial mobile network, wherein the user endpoint device is locked into a radio frequency band of the terrestrial mobile network, recording a second bitrate of the data transfer session, during a test interval in which a satellite of a non-terrestrial network that shares the radio frequency band with the terrestrial mobile network is executing a function that generates a data transmission to generate full-bandwidth noise signals, calculating a difference between the first bitrate that is recorded and the second bitrate that is recorded, and initiating, in response to the difference exceeding a threshold, an action to modify a parameter of at least one of the terrestrial mobile network or the non-terrestrial network to reduce an effect of channel interference resulting from the sharing.

In another example, a device includes a processor and a computer-readable medium storing instructions which, when executed by the processor, cause the processor to perform operations. The operations include recording a first bitrate of a data transfer session between a user endpoint device and a network element of a terrestrial mobile network, wherein the user endpoint device is locked into a radio frequency band of the terrestrial mobile network, recording a second bitrate of the data transfer session, during a test interval in which a satellite of a non-terrestrial network that shares the radio frequency band with the terrestrial mobile network is executing a function that generates a data transmission to generate full-bandwidth noise signals, calculating a difference between the first bitrate that is recorded and the second bitrate that is recorded, and initiating, in response to the difference exceeding a threshold, an action to modify a parameter of at least one of the terrestrial mobile network or the non-terrestrial network to reduce an effect of channel interference resulting from the sharing.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for measuring and minimizing the impact of co-band mobility on terrestrial network performance during satellite overpass, in accordance with the present disclosure;

FIG. 3 illustrates a flowchart of an example method for measuring and minimizing the impact of co-band mobility on terrestrial network performance during satellite overpass, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure describes a device, computer-readable medium, and method for measuring and minimizing the impact of co-band mobility on terrestrial network performance during satellite overpass. As discussed above, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs. In one example of the present disclosure, an NTN may be used to extend the mobile coverage of an LTE or 5G network.

For instance, a mobile network operator may utilize an NTN to extend the coverage of a TN into a geographic area in which it may be impractical or infeasible to deploy the necessary TN infrastructure (such as a remote, uninhabited, or sparsely inhabited geographic area). In this case, the coverage of the TN may be extended using a direct cellular-to-satellite NTN. To support a direct connection from a subscriber's user endpoint device which uses commercially available cellular technology (e.g., 2G, LTE, 5G, 6G, or other cellular technology) to a satellite, the satellite may be required to use radio frequency bands that the user endpoint device is already designed to communicate with. Furthermore, the satellite may be required to use either unlicensed radio frequency bands or radio frequency bands that are licensed to the mobile network operator.

Use of radio frequency bands that are licensed to the mobile network operator may require co-channel operation of the TN and NTN systems, and both the TN and the NTN may experience interference if co-channel cellular signals are broadcast in the same geographic area, in adjacent or otherwise closely located geographic areas, or in adjacent channels that are co-located or in close proximity to the coverage area of the TN. Co-channel or adjacent channel interference may reduce the signal-to-interference-and-noise ratio (SINR) of both the TN signals and the NTN signals, which may in turn degrade the spectral efficiencies of the TN and the NTN and ultimately lead to poor quality of experience for subscribers on either or both networks. However, because co-channel and adjacent channel interference are difficult to measure directly, the mobile network operator may not realize when interference is occurring or when the effects of the interference are likely to have a noticeable impact on quality of experience until the quality of experience has already suffered.

Examples of the present disclosure provide a way to estimate co-channel and adjacent channel interference when a TN and an NTN share a radio frequency band. In one example, a test device such as an off-the-shelf, cellular-enabled user endpoint device, may be placed within a terrestrial coverage area near the cell edge of the TN and locked into a radio frequency band of the TN that is under test (and that is also being utilized for transmissions by a satellite of an NTN). The test device may establish a data transfer session via the TN. Subsequently, during a test interval that overlaps with the data transfer session (where the test interval may be a predefined interval or an interval during which the satellite is detected to be passing overhead), the satellite that is passing overhead (or, alternatively, a terrestrial cellular base station such as an eNodeB) may activate an orthogonal channel noise simulator (OCNS) function that causes all physical resource blocks (PRBs) of the satellite signal to be used, thereby generating full-bandwidth “noise” signals in the satellite's terrestrial coverage area (within which the test device is positioned).

The bitrate of the data transfer session during the test interval may be logged as a time series and compared to the bitrate of the data transfer session outside of the test interval (e.g., when the test device is not generating the full-bandwidth noise signals) in order to estimate the effects of co-channel or adjacent channel interference on the throughput of the data transfer session (and on the broader customer experience). Once the co-channel or adjacent channel interference has been estimated, a remedial action may be initiated to minimize the co-channel or adjacent channel interference and thereby optimizing the quality of experience for subscribers who are currently connected to the NTN and/or TN.

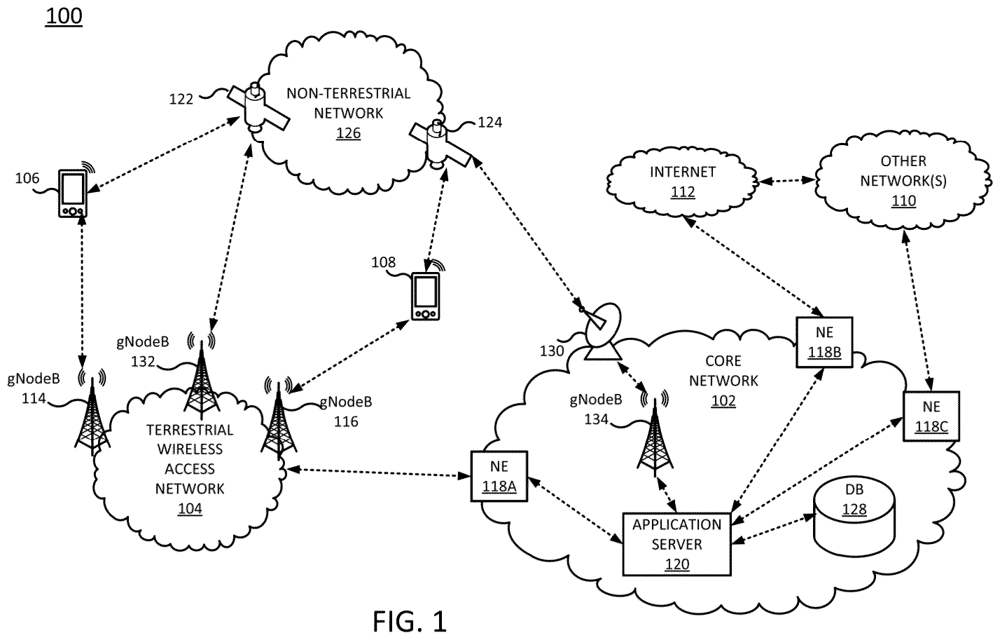

Although examples of the present disclosure are described within the example use case of a single satellite that is capable of broadcasting in the coverage area of a TN for a brief period of time, these examples can be extended to use cases in which a satellite signal is continuously available within the coverage area of the TN. For instance, the power control and beam locations of the TN and NTN can be coordinated as needed for the use case being evaluated. Examples of the present disclosure can also be extended to use cases in which a constellation of multiple satellites is capable of broadcasting in the coverage area of a TN (e.g., where each satellite in the constellation may broadcast in the coverage area of a TN during different, potentially overlapping intervals). These and other aspects of the present disclosure are discussed in greater detail in connection with FIGS. 1-4, below.

To better understand the present disclosure, FIG. 1 illustrates an example network 100, related to the present disclosure. As shown in FIG. 1, the network 100 connects mobile devices 106 and 108, as well as potentially other devices, with one another and with various other devices via a core network 102, a wireless access network 104 (e.g., a cellular network), other networks 110 and/or the Internet 112.

In one example, wireless access network 104 may comprise a terrestrial network, such as a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 104 may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G (e.g., 6G) and further generations. While the present disclosure is not limited to any particular type of wireless access network, in the illustrative example, wireless access network 104 is shown as a UMTS terrestrial radio access network (UTRAN) subsystem. Thus, elements 114, 116, and 132 may each comprise a next generation Node B (gNodeB).

In one example, each of the mobile devices 106 and 108 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. In one example, any one or more of the mobile devices 106 and 108 may have both cellular and non-cellular access capabilities and may further have wired communication and networking capabilities.

As illustrated in FIG. 1, network 100 includes a core network 102. In one example, core network 102 may combine core network components of a cellular network with components of a triple play service network; where triple play services may include telephone services, Internet services and television services to subscribers. For example, core network 102 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Core network 102 may also further comprise a broadcast television network, e.g., a traditional cable provider network or an Internet Protocol Television (IPTV) network, as well as an Internet Service Provider (ISP) network. The network elements 118A-118C may serve as gateway servers or edge routers to interconnect the core network 102 with other networks 110, Internet 112, wireless access network 104, other access networks, and so forth.

The core network 102 may also comprise an application server (AS) 120 and a database (DB) 128 that may be configured to monitor and store the locations and movements of satellites 122 and 124 of a non-terrestrial network 126, to monitor and analyze throughput statistics (e.g., bitrates of data transfers) experienced by the mobile devices 106 and 108, and/or to send instructions to the satellites 122 and 124, the mobile devices 106 and 108, and/or the network elements 114, 116, and 132 to modify their operating parameters or conditions to minimize the effects of co-channel interference, as discussed in further detail below. In one example, a cellular base station (e.g., a gNode B) 134 may communicatively couple the AS 102 to a satellite receiver 130 of the core network 102. The base stations 132 and 134 may be implemented within the satellites 122 and 124, respectively, or between the satellites satellite receiver 130 and the core network 102 (e.g., the application server 120) to convert the analog waveforms of cellular transmissions into digital format in the downlink (and to make the opposite conversion for the uplink). For ease of illustration, various additional elements of core network 102 are omitted from FIG. 1. For instance, core network 102 may also include other network elements that are not illustrated, such as television (TV) servers, content servers, application servers, and the like.

In addition, the network 100 may include the non-terrestrial network 126 that functions in a manner similar to the terrestrial wireless access network 104. For instance, the non-terrestrial network 126 may comprise an access network that provides broadband links via satellite, unmanned aerial vehicles, high-altitude platform systems, or any other yet to be developed future wireless/non-terrestrial network technology. While the present disclosure is not limited to any particular type of non-terrestrial network, in the illustrative example, non-terrestrial network 126 is shown as a satellite network. Thus, elements 122 and 124 may each comprise a satellite, such as an LEO satellite. In one example, the non-terrestrial network 126 may be controlled and/or operated by a mobile network operator as the terrestrial wireless access network 104. In another example, the non-terrestrial network 126 may be controlled and/or operated by a different entity than the mobile network operator who operates the terrestrial wireless access network 104.

In one particular example, the non-terrestrial network 126 may utilize radio frequency bands that are also utilized by the terrestrial wireless access network 104 (e.g., radio frequency bands that are licensed by a mobile network operator who operates the terrestrial wireless access network 104). As such, the terrestrial wireless access network 104 and the non-terrestrial network 126 may operate in a co-channel arrangement.

In one example, the AS 120 may be configured to monitor the locations and movements (e.g., speed and trajectory of motion) of the satellites 122 and 124 and to send commands to the mobile devices 106 and 108 that cause the mobile devices to activate a function to generate full-bandwidth noise signals during times that one of the satellites 122 or 124 is expected to pass over one of the mobile devices 106 or 108 (i.e., such that the mobile device 106 or 108 is within the terrestrial coverage area of the satellite 122 or 124). The AS 120 may further collect data relating to a data transfer session between the mobile device 106 or 108 and a device (e.g., application server) in the core network 102, one of the other networks 110, or in the Internet 112. The data relating to the data transfer may be collected both while the mobile device 106 or 108 has activated the function to generate the full-bandwidth noise. Based on the data relating to the data transfer, the AS 120 may estimate the impact of co-channel or adjacent channel interference on the throughput of the data transfer and may initiate one or more remedial actions to minimize that impact.

As a more specific example, mobile device 108 may be a test device that is connected to the terrestrial wireless access network 104. The mobile device 108 may be placed at the edge of a cell of the terrestrial wireless access network 104 and may be locked into a radio frequency band of the terrestrial wireless access network 104 that is to be tested. The AS 120 may communicate the radio frequency band that is to be tested to the mobile device 108.

The mobile device 108 may then establish a data transfer session, via the terrestrial wireless access network 104, with another device (e.g., a server or another device in the core network 102, in one of the other networks 110, or in the Internet 112). Data about the data transfer session (e.g., bitrate) may be communicated to the AS 120, which may store the data about the data transfer session as a first time series in the DB 128.

The AS 120 may also monitor the location and movement of the satellite 124 of the non-terrestrial network 126 and may estimate, based on the monitoring, when the mobile device 108 is expected to be within the terrestrial coverage area of the satellite 124. When the mobile device 108 is expected to be within the terrestrial coverage area of the satellite 124, the AS 120 may send a command to the satellite 124 to activate a function, such as an orthogonal channel noise simulator (OCNS) function, to generate a full-bandwidth noise signal that causes all PRBs of the satellite signal to be utilized. Alternatively, the mobile device 108 may autonomously determine when the mobile device 108 is expected to be within the terrestrial coverage area of the satellite 124 and when the satellite 124 should activate the function to generate the full-bandwidth nose signal. The time during which the function to generate the full-bandwidth noise signal is activated may be referred to as a test interval.

The mobile device 108 may maintain the data transfer session, at at least a threshold bitrate (which in one example is a maximum available bitrate), during the test interval. That is, the mobile device 108 may maintain the data transfer session while the function to generate the full-bandwidth noise signal is activated by the satellite 124. Data about the data transfer session (e.g., bitrate) may be communicated to the AS 120 during the test interval. The AS 120 may store the data about the data transfer session during the test interval as a second time series in the DB 128.

The AS 120 may compare the data about the data transfer session prior to the test interval (e.g., the first time series) to the data about the data transfer session during the test interval (e.g., the second time series) in order to estimate how the sharing of the radio frequency band by the terrestrial wireless access network 104 and the satellite 124 affects the data transfer session. For instance, the AS 120 may determine that the throughput of the data transfer session is reduced when the radio frequency band is shared by the terrestrial wireless access network 104 and the satellite 124.

In response to a result of the comparison, the AS 120 may initiate an action to minimize the effects of the sharing. The action may involve sending a command to the satellite, to other mobile devices (e.g., mobile device 106), and/or to network elements of the terrestrial wireless access network 104 (e.g., to elements 114, 116 and/or 132) to modify their operating parameters. For instance, the AS 120 may send a command to the satellite 124 to cause the satellite 124 to adjust its transmit power allocation, may send a command to a network element (e.g., element 114, 116, or 132) of the terrestrial wireless access network 104 to adjust an antenna configuration to change the antenna gain factor, may send a command to a network element (e.g., satellite 122 or 124) of the non-terrestrial network 126 to change a Doppler shift of the non-terrestrial wireless network's serving signal in response to the rise or set of the satellite 124, may send a command to another user endpoint device connected to the terrestrial wireless access network (e.g., user endpoint device 106) to adjust a power usage of the user endpoint device 106, or the like.

The above-described operations may be repeated for a plurality of different radio frequency bands shared by the terrestrial wireless network 104 and the non-terrestrial network 126. The operations may also be repeated during subsequent test intervals for the same radio frequency band. Due to atmospheric fading phenomena, variations in test equipment configurations, and/or data upload sequences, subsequent iterations of the operations may produce varying results that collectively exhibit a similar trend. Execution, correlation, and aggregation of multiple sets of test data (e.g., multiple time series logged during different test intervals) may allow for the AS 120 to detect more statistically significant trends, which may help to minimize the effects of transient conditions observed during any individual test interval.

Moreover, subsequent iterations of the operations with a large constellation of satellites and/or over a long period of time will produce a large data set with numerous parametric variables which are ideally suited to analysis via deep learning or other machine learning techniques. Analysis via machine learning would potentially enable a detailed understanding of satellite elevation angles, antenna gain factors, user endpoint device power usage, impacts of body or structure losses, and capacity limitations, among other factors, and of how those factors impact throughput and quality of experience. In further examples, analysis of the throughput measured during the test intervals may be used to infer the loss of spectral efficiency of the terrestrial wireless access network channel, the impact of SINR, and/or the reduction of the capacity of the terrestrial wireless access network within the terrestrial coverage areas of the satellite 122 and/or satellite 124.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Wireless access network 104 is not limited to a UMTS/UTRAN configuration. Non-terrestrial network 126 is not limited to a satellite network. Similarly, the present disclosure is not limited to an IP/MPLS network for VoIP telephony services, or any particular type of broadcast television network for providing television services, and so forth.

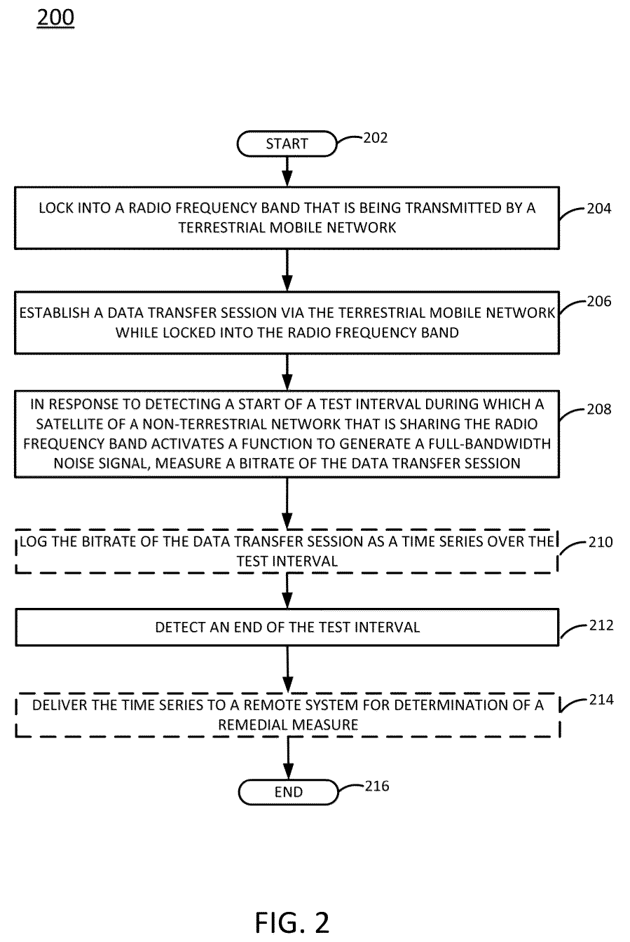

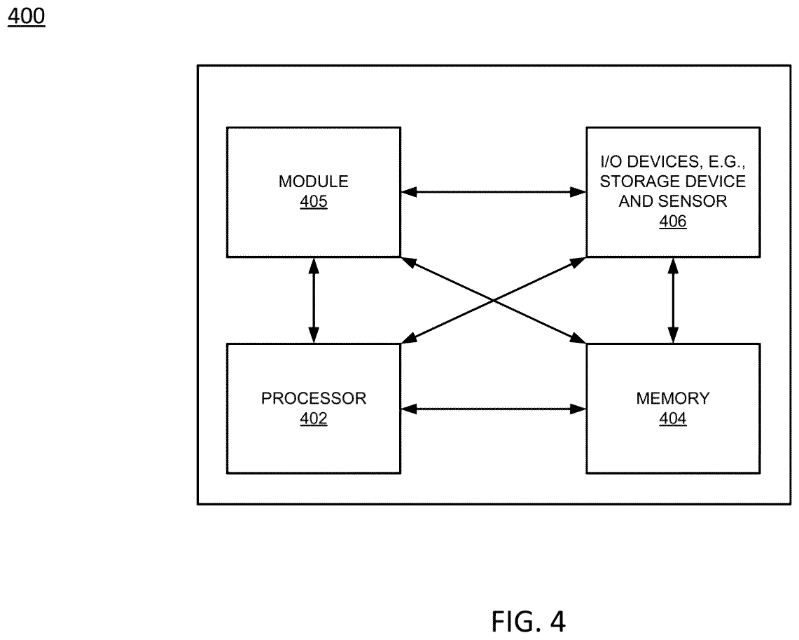

To further aid in understanding the present disclosure, FIG. 2 illustrates a flowchart of an example method 200 for estimating the impact of co-channel interference on mobile network throughput, in accordance with the present disclosure. In one example, the method 200 may be performed by a network element management system or application server of a mobile network operator core network, such as the AS 120 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may lock into a radio frequency band that is being transmitted by a terrestrial mobile network.

In one example, when the processing system locks onto the radio frequency band, the processing system is “listening” for signals that are broadcast in the radio frequency band. In one example, the radio frequency band comprises a radio frequency band that is licensed by a mobile network operator who operates the terrestrial mobile network. As discussed in further detail below, the radio frequency band may also be utilized by a non-terrestrial network, such as a cellular-to-satellite NTN.

The processing system in this example may be part of a user endpoint device, where the user endpoint device may, in one example, comprise any subscriber/customer endpoint device configured for wireless communication, such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like.

In one example, the terrestrial mobile network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the terrestrial mobile network may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations.

In one example, the processing system is physically located within a predefined distance of the edge of a cell that is served by the terrestrial mobile network. The precise physical location of the processing system may be determined to be within the coverage area and at a signal level that the mobile network operator wishes to test for channel interference.

In step 206, the processing system may establish a data transfer session via the terrestrial mobile network while locked into the radio frequency band. In one example, the data transfer session may be established using any one or more known communication protocols to establish a bi-directional data transfer session. In a further example, the data transfer session may comprise at least one of: a voice session or a data session. For instance, the data transfer session may involve a voice call, a data (e.g., multimedia) call, a data (e.g., video, audio, or the like) streaming session, a data transfer (e.g., multimedia download) session, and/or another type of data transfer session.

In one example, a duration of the data transfer session may be dynamically controlled to be of sufficient length to maintain at least a threshold data rate over the connection to the terrestrial mobile network over the duration of the data transfer session (where the threshold data rate may comprise an average data rate over the data transfer session, a peak data rate, a minimum data rate, or the like). In another example, the duration of the data transfer session may be predefined, in which case the duration may be a duration that is empirically determined to be of sufficient length to maintain at least the threshold data rate over the connection to the terrestrial mobile network over the duration of the data transfer session.

In another example, the complexity of the data transfer session may be controlled to ensure that the data rate of the data transfer session at least meets the threshold data rate over the connection to the terrestrial mobile network over the duration of the data transfer session. For instance, the data transfer session may favor more bitrate intensive applications, such as streaming of higher quality (resolution) video, over less bitrate intensive applications, such as streaming of lower quality video.

In one example, the data transfer session may be automated to repeatedly download and/or upload a specified file, such as a test file of a defined size, using randomized data to prevent the automatic application of data compression techniques (which would reduce the demand on the connection to the terrestrial mobile network).

In step 208, the processing system may, in response to detecting a start of a test interval during which a satellite of a non-terrestrial network that is sharing the radio frequency band activates a function to generate a full-bandwidth noise signal, measure a bitrate of the data transfer session. In one example, detecting the start of the test interval may comprise detecting when a current time coincides with the start time of a scheduled test interval. For instance, in cases where the radio frequency band is shared with an NTN that includes a geostationary satellite, periodic test intervals may be predefined according to a schedule.

In another example, detecting the start of the test interval may involve detecting when a satellite of the NTN is passing (or is within a threshold distance of passing) overhead. The satellite may comprise a portion of the physical infrastructure of the NTN, where the NTN may comprise a plurality of satellites including the satellite.

For instance, in cases where the radio frequency band is shared with an NTN that includes a low Earth orbit (LEO) satellite, the terrestrial coverage area of the satellite may constantly change due to changes in the satellite's physical location and angular altitude as the satellite orbits the Earth's surface. Thus, the physical location of the processing system may be within the terrestrial coverage area of the satellite at some times and outside the terrestrial coverage area of the satellite at other times. In one example, the processing system may detect when the processing system is within the terrestrial coverage area of the satellite (e.g., by detecting signals in the radio frequency band that are emitted by the satellite), which may indicate that the test interval should start. In another example, a remote application server or other devices may track the position of the satellite relative to the processing system and may send a command to the processing system to begin the test interval when the processing system is expected to be within the terrestrial coverage area of the satellite.

In one example, a time at which the user endpoint device is expected to be physically located within the terrestrial coverage area of the satellite may be estimated based on knowledge of at least one of: the physical location of the user endpoint device, the current location of the satellite, the current trajectory of the satellite, or the current speed of motion of the satellite. In one example, the estimate may be generated using a machine learning algorithm (such as a support vector machine, a neural network, a Bayes network, a decision tree, or the like) that takes any one or more of the aforementioned parameters as input and generates as an output the time at which the user endpoint device is expected to be physically located within the terrestrial coverage area of the satellite.

In one example, the function that generates the full-bandwidth noise signals may be an OCNS function of the satellite. The OCNS function, when activated, may cause all physical resource blocks (PRBs) of the signal from the satellite to be utilized, which results in the generation of the full-bandwidth noise signal in a portion of the satellite's terrestrial coverage surrounding the processing system.

In optional step 210 (illustrated in phantom), the processing system may log the bitrate of the data transfer session as a time series over the test interval. In one example, the processing system may monitor the bitrate of the data transfer session over the test interval, as discussed above. The bitrate may be logged as a time series and stored locally, e.g., in a memory of a user endpoint device of which the processing system is a part.

In one example, it may be expected that the time series will show a reduction in the throughput of the data transfer session during the test interval. This reduction in throughput may be largely due to the full-bandwidth noise signal that the satellite is generating, which will reduce the SINR of the signals emitted by the terrestrial mobile network in the radio frequency band. As discussed in further detail below, the time series may be correlated with the pass of the satellite of the NTN in order to infer the overall effects of the NTN interference on the throughput of the terrestrial mobile network.

Step 210 may be considered an optional step because, in some examples, the bitrate of the data transfer session may be measured and logged by a remote device, such as a probe or an application server that monitors the data transfer session. In such an example, the processing system may need only to maintain the data transfer session while the function to generate the full-bandwidth noise signal is activated by the satellite, and the remote device will monitor and log the bitrate during the test interval.

In step 212, the processing system may detect an end of the test interval. In one example, detecting the end of the test interval may comprise detecting when a current time coincides with the end time of a scheduled test interval. For instance, as discussed above, in cases where the radio frequency band is shared with an NTN that includes a geostationary satellite, periodic test intervals may be predefined according to a schedule. Alternatively, detecting the end of the test interval may comprise detecting when a current time coincides with a predefined period of time after a satellite of the NTN has passed overhead. This approach enables the establishment of a “reverse baseline” by measuring conditions free of an interfering signal, observing the impact of the addition of the interfering signal on the conditions, and then measuring the impact of the removal of the interfering signal on the conditions.

In another example, detecting the end of the test interval may involve detecting when a satellite of the NTN is no longer passing (or is within a threshold distance of no longer passing) overhead. For instance, as discussed above, in cases where the radio frequency band is shared with an NTN that includes a low Earth orbit (LEO) satellite, the terrestrial coverage area of the satellite may constantly change due to changes in the satellite's angular altitude. Thus, physical location of the processing system may be within the terrestrial coverage area of the satellite at some times and outside the terrestrial coverage area of the satellite at other times. In one example, the processing system may detect when the processing system is no longer within the terrestrial coverage area of the satellite (e.g., by no longer detecting signals in the radio frequency band that are emitted by the satellite), which may indicate that the test interval should end. In another example, a remote application server or other devices may track the position of the satellite relative to the processing system and may send a command to the processing system to end the test interval when the processing system is expected to no longer be within the terrestrial coverage area of the satellite.

In another example, detecting the end of the test interval may involve detecting that the satellite has deactivated the function that generates the full-bandwidth noise signals. Where the function that generates the full-bandwidth noise signals is an OCNS function of the satellite, deactivating the function may involve deactivating the OCNS function (e.g., so that any physical PRBs of the signal from the satellite that are utilized by the processing system are released).

In step optional 214 (illustrated in phantom), the processing system may deliver the time series to a remote system for determination of a remedial measure. In one example, the remote system may be a remote application server, such as an application server operated by the mobile network operator and located in a core network of the mobile network operator. As discussed in further detail below, the remote system may correlate the time series with the passing of the satellite of the NTN in order to infer the overall effects of the NTN interference on the throughput of the terrestrial mobile network. Based on the overall effects that are inferred, the remote system may initiate a remedial action to minimize the interference. The remedial action may involve adjusting a satellite elevation angle, an antenna gain factor of a base station of the terrestrial mobile network, a power usage of a user endpoint device, or another parameter of an item of network equipment. For instance, the remote system may send a command to the satellite to cause the satellite to adjust its transmit power allocation, may send a command to a network element of the non-terrestrial mobile network to adjust a Doppler shift of the non-terrestrial mobile network's serving signal in response to the rise or set of the satellite, or the like.

The method 200 may end in step 216.

Steps 204-214 may be repeated for a plurality of different radio frequency bands shared by the terrestrial mobile network and the NTN. Moreover, steps 208-214 may be repeated during subsequent test intervals for the same radio frequency band. Due to atmospheric fading phenomena, variations in test equipment configurations, and/or data upload sequences, subsequent iterations of the method 200 (or steps of the method 200) may produce varying results that collectively exhibit a similar trend. Execution correlation, and aggregation of multiple sets of test data (e.g., multiple time series logged during different test intervals) may allow for the detection of more statistically significant trends, which may help to minimize the effects of transient conditions observed during any individual test interval.

Moreover, subsequent iterations of the method 200 (or steps of the method 200) with a large constellation of satellites and/or over a long period of time will produce a large data set with numerous parametric variables which are ideally suited to analysis via deep learning or other machine learning techniques. Analysis via machine learning would potentially enable a detailed understanding of satellite elevation angles, antenna gain factors, user endpoint device power usage, impacts of body or structure losses, and capacity limitations, among other factors, and of how those factors impact throughput and quality of experience. In further examples, an analysis of the throughput measured during the test intervals may be used to infer the loss of spectral efficiency of the terrestrial mobile network channel, the impact of SINR, and/or the reduction of the capacity of the terrestrial mobile network within the satellite coverage footprint.

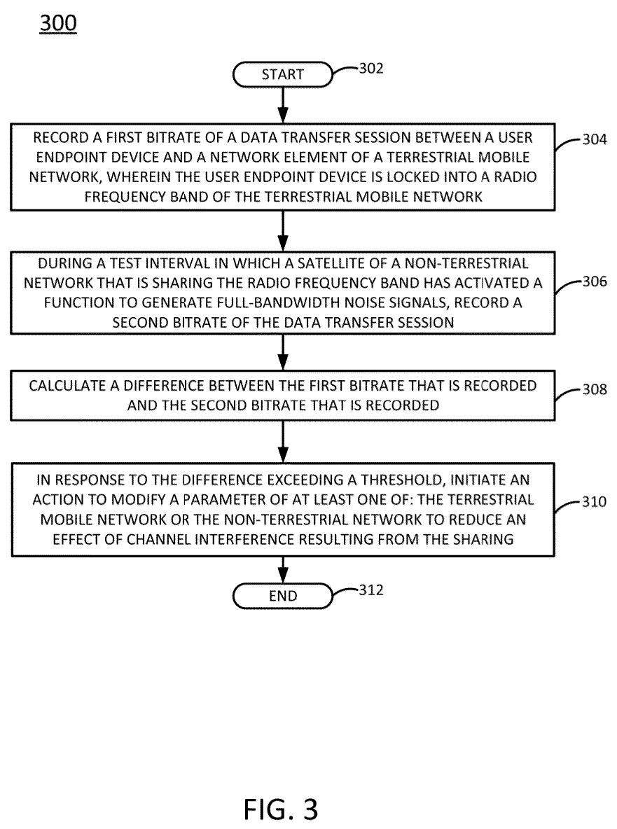

FIG. 3 illustrates a flowchart of an example method 300 for estimating the impact of co-channel interference on mobile network throughput, in accordance with the present disclosure. In one example, the method 300 may be performed by an application server, such as the AS 120 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may record a first bitrate of a data transfer session between a user endpoint device and a network element of a terrestrial mobile network, wherein the user endpoint device is locked into a radio frequency band of the terrestrial mobile network.

In one example, the radio frequency band comprises a radio frequency band that is licensed by a mobile network operator who operates the terrestrial mobile network. As discussed in further detail below, the radio frequency band may also be utilized by a non-terrestrial network, such as a cellular-to-satellite NTN.

In one example, the terrestrial mobile network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the terrestrial mobile network may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations.

The user endpoint device may comprise any subscriber/customer endpoint device configured for wireless communication, such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. In one example, the user endpoint device is physically located within a predefined distance of the edge of a cell that is served by the terrestrial mobile network. The precise physical location of the user endpoint device may be determined to be within the coverage area and at a signal level that the mobile network operator wishes to test for channel interference.

In one example, the data transfer session may be established using any one or more known communication protocols to establish a bi-directional data transfer session. In a further example, the data transfer session may comprise at least one of: a voice session or a data session. For instance, the data transfer session may involve a voice call, a data (e.g., multimedia) call, a data (e.g., video, audio, or the like) streaming session, a data transfer (e.g., multimedia download) session, and/or another type of data transfer session.

In one example, a duration of the data transfer session may be dynamically controlled by the user endpoint device to be of sufficient length to maintain at least a threshold data rate over the connection to the terrestrial mobile network over the duration of the data transfer session (where the threshold data rate may comprise an average data rate over the data transfer session, a peak data rate, a minimum data rate, or the like). In another example, the duration of the data transfer session may be predefined, in which case the duration may be a duration that is empirically determined to be of sufficient length to maintain at least the threshold data rate over the connection to the terrestrial mobile network over the duration of the data transfer session. In another example, the duration of the data transfer session may be determined to last for a predefined period of time after a satellite of an NTN that is sharing the radio frequency band has passed overhead. As discussed above, this approach enables the establishment of a “reverse baseline” by measuring conditions free of an interfering signal, observing the impact of the addition of the interfering signal on the conditions, and then measuring the impact of the removal of the interfering signal on the conditions.

In another example, the complexity of the data transfer session may be controlled by the user endpoint device to ensure that the data rate of the data transfer session at least meets the threshold data rate over the connection to the terrestrial mobile network over the duration of the data transfer session. For instance, the data transfer session may favor more bitrate intensive applications, such as streaming of higher quality (resolution) video, over less bitrate intensive applications, such as streaming of lower quality video.

In one example, the data transfer session may be automated to repeatedly download and/or upload a specified file, such as a test file of a defined size, using randomized data to prevent the automatic application of data compression techniques (which would reduce the demand on the connection to the terrestrial mobile network).

The processing system in this example may be part of an application server or another system that is configured to monitor for channel interference and to adjustment parameters of network elements to reduce the effects of channel interference. In one example, the application server or another system may be physically located within a core network of the mobile network operator. In one example, the processing system may collect information about the data transfer session, including data from which the first bitrate may be computed or inferred, directly from the user endpoint device. For instance, the user endpoint device may report the first bitrate as a first time series over an interval of time (e.g., a non-test interval). In another example, the processing system may collect the information about the data transfer session indirectly, such as via one or more network probes that are located to monitor the user endpoint device. In this case, the processing system may compute the first time series over the interval of time from raw data collected from the network probe(s).

In step 306, the processing system may record, during a test interval in which a satellite of a non-terrestrial network that shares the radio frequency band with the terrestrial mobile network generates a data transmission has activated a function to generate full-bandwidth noise signals, a second bitrate of the data transfer session. In one example (e.g., where the radio frequency band is shared with an NTN that includes a geostationary satellite), the test interval may comprise one of a plurality of periodic test intervals that may be predefined according to a schedule. In another example (where the radio frequency band is shared with an NTN that includes a LEO satellite), the test interval may be dynamically determined by either the user endpoint device or by the processing system by detecting when a satellite of the NTN is passing (or is within a threshold distance of passing) over the user endpoint device.

In one example, a time at which the user endpoint device is expected to be physically located within the terrestrial coverage area of the satellite may be estimated based on knowledge of at least one of: the physical location of the user endpoint device, the current location of the satellite, the current trajectory of the satellite, or the current speed of motion of the satellite. In one example, the estimate may be generated using a machine learning algorithm (such as a support vector machine, a neural network, a Bayes network, a decision tree, or the like) that takes any one or more of the aforementioned parameters as input and generates as an output the time at which the user endpoint device is expected to be physically located within the terrestrial coverage area of the satellite.

Where the processing system dynamically determines the test interval, the processing system may send commands to the satellite to start and end the test interval (e.g., by activating the function to generate full-bandwidth noise signals). In one example, the function that generates the full-bandwidth noise signals may be an OCNS function of the satellite. The OCNS function, when activated, may cause all physical resource blocks (PRBs) of the signal from the satellite to be utilized, which results in the generation of the full-bandwidth noise signal in a portion of the satellite's terrestrial coverage surrounding the user endpoint device.

During the test interval, the processing system may collect information about the data transfer session, including data from which the second bitrate may be computed or inferred. In one example, the data may be collected directly from the user endpoint device. For instance, the user endpoint device may report the second bitrate as a second time series over the test interval. In another example, the processing system may collect the information about the data transfer session indirectly, such as via one or more network probes that are located to monitor the user endpoint device. In this case, the processing system may compute the second time series over the test interval from raw data collected from the network probe(s).

In step 308, the processing system may calculate a difference between the first bitrate that is recorded and the second bitrate that is recorded. In one example, it may be expected that a reduction in the throughput of the data transfer session will be observed during the test interval. This reduction in throughput may be largely due to the full-bandwidth noise signal that the satellite generates during the test interval, which will reduce the SINR of the signals emitted by the terrestrial mobile network in the radio frequency band. The processing system may correlate the second time series with the passing of the satellite of the NTN in order to infer the overall effects of the NTN interference on the throughput of the terrestrial mobile network.

In step 310, the processing system may initiate, in response to the difference exceeding a threshold, an action to modify a parameter of at least one of: the terrestrial mobile network or the non-terrestrial network to reduce an effect of channel interference resulting from the sharing. In one example, based on the overall effects that are inferred, the processing system may initiate a remedial action to minimize the interference. The remedial action may involve adjusting a satellite power or antenna configuration, an antenna gain factor of a base station of the terrestrial mobile network, a power usage of a user endpoint device, and/or another parameter of an item of network equipment. For instance, the processing system may send a command to the satellite to cause the satellite to adjust its power transmit allocation, may send a command to the satellite to cause the satellite to change a Doppler shift of the non-terrestrial network's serving signal in response to the rise or set of the satellite, may send a command to a network element (e.g., base station) of the terrestrial mobile network to adjust an antenna configuration to change the antenna gain factor, may send a command to another user endpoint device connected to the terrestrial mobile network (e.g., a user endpoint device other than the user endpoint device involved in the data transfer) to adjust a power usage of the user endpoint device, or the like.

The method 300 may end in step 312.

Steps 304-310 may be repeated for a plurality of different radio frequency bands shared by the terrestrial mobile network and the NTN. Moreover, steps 304-310 may be repeated during subsequent test intervals for the same radio frequency band. Due to atmospheric fading phenomena, variations in test equipment configurations, and/or data upload sequences, subsequent iterations of the method 300 (or steps of the method 300) may produce varying results that collectively exhibit a similar trend. Execution correlation, and aggregation of multiple sets of test data (e.g., multiple time series logged during different test intervals) may allow for the detection of more statistically significant trends, which may help to minimize the effects of transient conditions observed during any individual test interval.

Although not expressly specified above, one or more steps of the method 200 or method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, a user endpoint device (such as might be used to perform the method 200) or an application server or another network element of a non-terrestrial network (such as might be used to perform the method 300) could be implemented as illustrated in FIG. 4.

As depicted in FIG. 4, the system 400 comprises a hardware processor element 402, a memory 404, a module 405 for estimating the impact of co-channel interference on mobile network throughput, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for estimating the impact of co-channel interference on mobile network throughput may include circuitry and/or logic for performing special purpose functions relating to monitoring the movements of satellites in a non-terrestrial network. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for estimating the impact of co-channel interference on mobile network throughput (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for estimating the impact of co-channel interference on mobile network throughput (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
recording, by a processing system including at least one processor, a first bitrate of a data transfer session between a user endpoint device and a network element of a terrestrial mobile network, wherein the user endpoint device is locked into a radio frequency band of the terrestrial mobile network;
recording a second bitrate of the data transfer session, by the processing system, during a test interval in which a satellite of a non-terrestrial network that shares the radio frequency band with the terrestrial mobile network is executing a function that generates a data transmission to generate full-bandwidth noise signals;
calculating, by the processing system, a difference between the first bitrate that is recorded and the second bitrate that is recorded; and
initiating, by the processing system in response to the difference exceeding a threshold, an action to modify a parameter of at least one of: the terrestrial mobile network or the non-terrestrial network to reduce an effect of channel interference resulting from the sharing of the radio frequency band.

2. The method of claim 1, wherein the processing system is part of a system that is physically located within the terrestrial mobile network.

3. The method of claim 2, wherein the system collects data about the data transfer session directly from the user endpoint device.

4. The method of claim 2, wherein the system collects data about the data transfer session directly from a network probe located within the terrestrial mobile network.

5. The method of claim 1, wherein the user endpoint device is physically located within a predefined distance of an edge of a cell that is served by the terrestrial mobile network.

6. The method of claim 5, wherein the user endpoint device is physically located to test a desired signal level within the terrestrial mobile network.

7. The method of claim 1, wherein the data transfer session comprises at least one of: a voice session or a data session.

8. The method of claim 1, wherein a duration of the data transfer session is dynamically controlled to be of a length that is sufficient to maintain at least a threshold data rate over a connection between the user endpoint device and the network element over the duration of the data transfer session.

9. The method of claim 1, wherein a complexity of the data transfer session is controlled to ensure that a data rate of the data transfer session at least meets a threshold data rate over a connection between the user endpoint device and the network element over a duration of the data transfer session.

10. The method of claim 1, wherein the processing system sends a command to the satellite at a start of the test interval to cause the satellite to activate the function and sends another command to the satellite at an end of the test interval to cause the satellite to deactivate the function.

11. The method of claim 10, wherein the processing system detects the start of the test interval in response to determining when the user endpoint device will be physically located within a terrestrial coverage area of the satellite and detects the end of the test interval in response to determining when the user endpoint device will no longer be physically located within the terrestrial coverage area of the satellite.

12. The method of claim 10, wherein the processing system detects the start of the test interval and the end of the test interval based on a predefined schedule.

13. The method of claim 1, wherein the function is an orthogonal channel noise simulator that causes all physical resource blocks of a signal emitted by the satellite to be utilized.

14. The method of claim 1, wherein the first bitrate is recorded as a first time series and the second bitrate is recorded as a second time series.

15. The method of claim 14, wherein the calculating comprises correlating the second time series with a passing of the satellite.

16. The method of claim 1, wherein the initiating comprises sending a command to the satellite to cause the satellite to adjust a transmit power allocation of the satellite.

17. The method of claim 1, wherein the initiating comprises sending a command to a network element to cause the network element to adjust an antenna configuration of the network element to change a gain factor of the antenna configuration.

18. The method of claim 1, wherein the initiating comprises sending a command to another user endpoint device that is connected to the terrestrial mobile network to cause the another user endpoint device to adjust a power usage of the another user endpoint device.

19. A non-transitory computer-readable medium storing instructions which, when executed by a processing system including at least one processor, cause the processing system to perform operations, the operations comprising:
recording a first bitrate of a data transfer session between a user endpoint device and a network element of a terrestrial mobile network, wherein the user endpoint device is locked into a radio frequency band of the terrestrial mobile network;
recording a second bitrate of the data transfer session, during a test interval in which a satellite of a non-terrestrial network that shares the radio frequency band with the terrestrial mobile network is executing a function that generates a data transmission to generate full-bandwidth noise signals;
calculating a difference between the first bitrate that is recorded and the second bitrate that is recorded; and
initiating, in response to the difference exceeding a threshold, an action to modify a parameter of at least one of the terrestrial mobile network or the non-terrestrial network to reduce an effect of channel interference resulting from the sharing of the radio frequency band.

20. A device comprising:
a processing system including at least one processor; and
a computer-readable medium storing instructions which, when executed by the processing system, cause the processing system to perform operations, the operations comprising:
recording a first bitrate of a data transfer session between a user endpoint device and a network element of a terrestrial mobile network, wherein the user endpoint device is locked into a radio frequency band of the terrestrial mobile network;
recording a second bitrate of the data transfer session, during a test interval in which a satellite of a non-terrestrial network that shares the radio frequency band with the terrestrial mobile network is executing a function that generates a data transmission to generate full-bandwidth noise signals;
calculating a difference between the first bitrate that is recorded and the second bitrate that is recorded; and
initiating, in response to the difference exceeding a threshold, an action to modify a parameter of at least one of the terrestrial mobile network or the non-terrestrial network to reduce an effect of channel interference resulting from the sharing of the radio frequency band.
